(19) United States
(12) Patent Application Publication
(10) Pub. No.: US 2010/0221632 A1
(43) Pub. Date: Sep. 2, 2010

(54) Method and Apparatus for Forming a Wetting Nominal Value for a Fuel Cell Unit

(75) Inventors: Sabine Flanz, Hochstetten (DE); Martin Gruber, Stuttgart (DE); Stefan Kaindl, Reutlingen (DE); Michael Kurrle, Kirchheim (DE); Matthias Lederbogen, Blaubeuren (DE); Gerald Post, Suessen (DE); Volker Schempp, Holzmaden (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/678,919

(22) PCT Filed: Jul. 16, 2008
(86) PCT No.: PCT/EP08/05791

§ 371 Date: May 11, 2010

(30) Foreign Application Priority Data
Sep. 19, 2007 (DE) 10 2007 044 759.2

(51) Int. Cl. H01M 8/04

(52) U.S. Cl. 429/450

(57) ABSTRACT

In a method and apparatus for wetting a fuel cell unit on the basis of a predetermined dew point nominal value as a function of the operating state of the fuel cell unit, a corrected dew point nominal value is determined using a predetermined dew point nominal value, a component-specific correction value, and a process correction value. The corrected dew point nominal value is used to set the required amount of water for optimum wetting of the fuel cell unit.

This application is a national stage of PCT International Application No. PCT/EP2008/005791, filed Jul. 16, 2008, which claims priority under 35 U.S.C. §119 to German Patent Application No. 10 2007 044759.2, filed Sep. 19, 2007, the entire disclosure of which is herein expressly incorporated by reference.

### BACKGROUND AND SUMMARY OF THE INVENTION

The present invention relates to a method and apparatus for wetting a fuel cell unit based on predeterminable dew point nominal value as a function of the operating state of the fuel cell unit.

German patent document DE 101 10 419 A1 discloses a fuel cell system which has a wetting device that can wet a fuel cell, even when the wetting has become inadequate while starting up the fuel cell and during its normal operation. A water collecting apparatus, which collects water in the off-gas from the fuel cell, as well as an auxiliary wetter, which wets a gas supply using water collected by the water collecting apparatus, are provided separately from the wetter of the type through which water can pass. The water collecting apparatus has a vapor/liquid separator and a collected water storage tank, and the auxiliary wetter has a non-return valve, a collected water feed pump, an auxiliary wetting tube and an injector. The collected water in the collected water storage tank is passed through a collected water feed pump, vaporized by the injector, and supplied to the inlet side of the fuel cell.

One object of the invention is to provide an improved method and apparatus for wetting of a fuel cell unit.

This and other objects and advantages are achieved by the method and apparatus according to the invention for wetting a fuel cell unit based on a predeterminable dew point nominal value, as a function of the operating state of the fuel cell unit. According to the invention, the predetermined dew point nominal value, a component-specific correction value and a process correction value are used to determine a corrected dew point nominal value, and the required amount of water for optimum wetting of the fuel cell unit is set based thereon. Consideration of the component-specific correction value and the process correction value allows very fine control of the wetting process, and the fuel cell unit can therefore be operated in an optimum wetting range, avoiding voltage drops and increasing the life of the fuel cell unit, by preventing excessively dry operation.

The corrected dew point nominal value is determined on the one hand using the component-specific correction value, thus taking account of specific component characteristics, such as the wetter efficiency, compression energy for vaporization of water, and/or a component temperature.

On the other hand, the corrected dew point nominal value is determined based on the process correction value, which includes specific process characteristics, such as the vaporization energy in a wetting device and a fuel temperature.

A saturation vapor pressure, associated with the corrected dew point nominal value, for water is also determined. This saturation vapor pressure and currently measured operating characteristic variables (for example, a volume flow and the pressure of a fuel as well as the mass flow of an oxidant), or calculated operating characteristic variables (for example, the mass flow of water), are used to determine the required amount of water to wet the fuel cell unit, so that wetting is optimally matched to the current operating states of the fuel cell unit in all events.

The required amount of water for wetting is distributed via one or more wetting devices arranged in series and/or in parallel, which has the advantage that it results in uniform wetting.

In one advantageous refinement of the invention, in the case of a fuel cell with upstream fuel gas reforming, the required amount of water for wetting an anode can be set based on a reformat cooler and a downstream condensation separator. This advantageously avoids the need for a separate wetting device, thus achieving cost savings and a gain in space.

In summary, optimized wetting of the fuel cell improves the reliability and the efficiency of the fuel cell unit.

Other objects, advantages and novel features of the present invention will become apparent from the following detailed description of the invention when considered in conjunction with the accompanying drawings.

### BRIEF DESCRIPTION OF THE DRAWINGS

FIG. 1 shows, schematically, a block diagram of one possible embodiment of the method and apparatus according to the invention for a fuel cell unit; and

FIG. 2 shows, schematically, a block diagram of another possible embodiment of the method and apparatus according to the invention, for a fuel cell unit with upstream fuel gas reformation on the anode side.

### DETAILED DESCRIPTION OF THE INVENTION

Mutually corresponding parts are provided with the same reference symbols in all the figures.

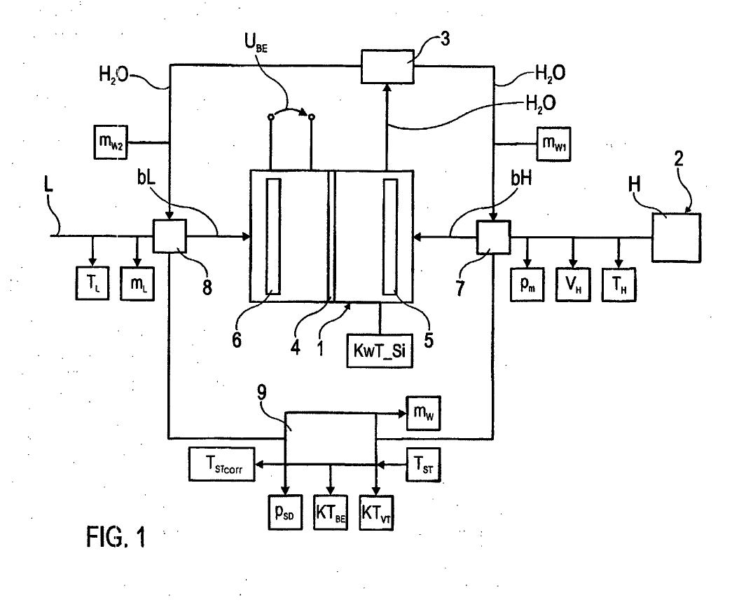

FIG. 1 illustrates the method and apparatus according to the invention for the fuel cell unit 1, in which hydrogen (H) is taken as fuel from a supply container 2 on the anode side. On the cathode side, air (L) is supplied as an oxidant to the fuel cell unit 1.

During catalytic oxidation of the hydrogen H with the oxygen contained in the air L, water (H₂O) is produced as a reaction product and collected in a supply container 3, and an electrical voltage U_{BE} is produced. An ion exchange membrane 4 separates an anode 5 and a cathode 6, and makes it possible for ions of hydrogen H to be passed as an intermediate product from the catalytic oxidation process through the ion exchange membrane 4 to the air L as the oxidant.

This ion exchange membrane 4 must be wetted with water (H₂O) in order to be conductive for ions of hydrogen H. Such wetting must be at a specific wetting level in order to achieve high efficiency from the fuel cell unit 1. For example, if the fuel cell unit 1 is operated with too little wetting, its life and the maximum achievable electrical power fall. If the fuel cell unit 1 is operated with a wetting level that is too high, this can lead to condensation of moisture, resulting in closure of conduction channels in the ion exchange membrane 4, which can lead to local overheating and to the ion exchange membrane 4 being burnt through.

In order to wet the ion exchange membrane 4, one or more wetting devices 7 are provided on the anode side to wet the fuel hydrogen H with water H₂O, and one or more wetting devices 8 on the cathode side wet the oxidant air L with water H₂O. A corrected dew point nominal value T_{STcorr} is determined by a control unit 9 in order to calculate the amount of water M_{w} required for wetting. A dew point nominal value T_{ST} for optimum wetting is predetermined for this purpose, as a function of various environmental influences (such as temperature and/or cold starting of the fuel cell unit BE), and as a function of various operating characteristic variables (for example, the hydrogen volume flow V_{H}, the hydrogen temperature T_{H} and the air temperature T_{L}). The dew point nominal value T_{ST} is determined empirically, or is derived from an event-oriented wetting process.

The corrected dew point nominal value T_{STcorr} is in this case obtained from the difference between the dew point nominal value T_{ST}, a component-specific correction value KT_{BE} and a process correction value KT_{VT} using:

T_{STkorr}=T_{STkorr}−KT_{BE}−KT_{VT} [1]

In this case, the component-specific correction value KT_{BE} is used to take account of specific component characteristics, such as the wetter efficiency, the compression energy and/or a component temperature. For example, the control unit 9 corrects the dew point nominal value T_{ST} if the component temperature is too low, with the component temperature being determined via a current cooling water temperature KwT_Si:

KT_{BE}=T_{ST}−KwT_{—}Si for T_{ST}>KwT_{—}Si [2]

The process correction value KT_{VT} is used to take account of process characteristics, and the dew point nominal value T_{ST} is corrected, for example, on the basis of the vaporization energy being too low in a wetting device 7, 8 using the control unit 9.

The control unit 9 uses the corrected dew point nominal value T_{STcorr} to determine the vapor pressure in the saturation state P_{SD} using

P_{SD}=611*e^{(a*T}^{_{STkorr}}^{+b*T}^{_{STkorr}}^{²}^{+c*T}^{_{STkorr}}^{³}^{+d*T}^{_{STkorr}}^{⁴}^{).} [3]

In this case a, b, c and d are fixed predetermined constants.
a=0.07257
b=−0.0002937
c=0.000000981
d=−1.901*10⁻⁹

The control unit 9 uses the vapor pressure in the saturation state P_{SD}, a molar mass ratio of air and water with a value of 0.622, an air mass flow m_{L} and a medium pressure pM of the hydrogen H to determine the required amount of water m_{w} associated with the corrected dew point nominal value T_{STcorr} for wetting the fuel cell unit BE.

$${m}_{w} = 0.622 * {m}_{L} * \frac{{p}_{SD}}{{p}_{M} - {p}_{SD}} . \qquad [ 4 ]$$

In order to wet the hydrogen H, a first amount of water m_{w1} determined by the control unit 9 is supplied to one or more wetting devices 7 on the anode side, and to wet the air, a second amount of water m_{w2} that has been determined is supplied to one or more wetting devices 8 on the cathode side. When a plurality of wetting devices 7, 8 are used, they may be arranged both in series and in parallel.

The wetting of the ion exchange membrane 4, controlled by means of the control unit 9, on the basis of the wetted hydrogen bH and the wetted air bL results in optimum wetting of the fuel cell unit 1, matched to the environmental conditions and to the conditions in the fuel cell unit BE itself.

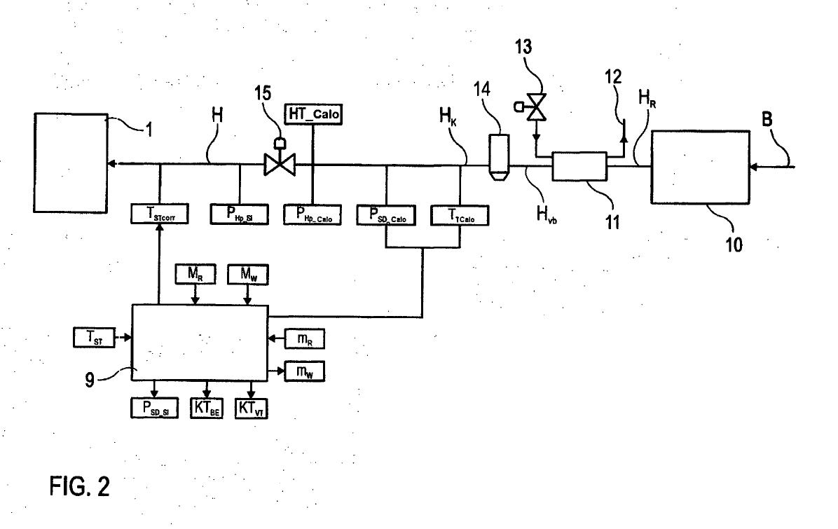

FIG. 2 shows one possible application of the method according to the invention and of the apparatus for a fuel cell unit 1 with fuel gas reformation upstream on the anode side. In this case, a fuel B is reformed by a reformer 10 to form hydrogen H_{R}. The hydrogen H_{R} on the output side of the reformer 10 has a very high moisture content.

This hydrogen H_{R} is cooled by reformate cooler 11, to an extent that can be controlled by a control valve 13 in a cooling circuit 12. After being cooled down, a completely wetted hydrogen H_{vb} is produced at the output of the reformation cooler 11.

The completely wetted hydrogen H_{vb} is passed through a condensation separator 14. If the efficiency of the latter is very high, the proportion of condensation in the hydrogen H_{K} at an output of the condensation separator 14 is relatively low. The temperature HT_Calo measured at this point corresponds to the dew point temperature at the same point.

A control unit 9 uses the corrected dew point nominal value T_{STcorr} on the input side of the anode 5 of the fuel cell unit 1 to determine the required dew point value T_{TCalo} downstream from the condensation separator 14. The latter is in turn used to control the control valve 13 in the cooling circuit 12, thus setting the temperature of the completely wetted hydrogen H_{vb} produced on the output side of the reformate cooler 11.

As in the case of the method according to the invention described in FIG. 1, the control unit 9 determines the corrected dew point nominal value T_{STcorr} using:

T_{STkorr}=T_{STkorr}−KT_{BE}−KT_{VT} [5]

The vapor pressure in the saturation state P_{SD}_{_{—}}_{Si} at the anode-side inlet to the fuel cell unit 1 is also obtained, in the same way as in the method described in FIG. 1, using:

P_{SD}_{_{—}}_{Si}=611*e^{(a*T}^{_{STkorr}}^{+b*T}^{_{STkorr}}^{²}^{+c*T}^{_{STkorr}}^{³}^{+d*T}^{_{STkorr}}^{⁴}^{).} [6]

The control unit 9 determines the required amount of water m_{w} associated with the corrected dew point T_{STcorr} by means of this vapor pressure in the saturation state P_{SD}_{_{—}}_{Si}, a reformation molar mass M_{R} of the hydrogen H, a water molar mass M_{w}, a reformate mass flow m_{R} of the hydrogen H and the media pressure at the fuel cell inlet P_{Hp}_{_{—}}_{Si}.

Since the mass flow of the amount of water m_{w} required and contained in the hydrogen H is constant upstream and downstream of a pressure-maintenance valve 15, the saturation vapor pressure P_{SD}_{_{—}}_{Calo} downstream from the condensation separator 14 can be determined using:

$${p}_{SD \_ Kalo} = \frac{{p}_{Hp - Kalo} * {m}_{W}}{\frac{{M}_{R}}{{M}_{W}} * {m}_{R} + {m}_{W}} . \qquad [ 7 ]$$

To do this, it is necessary to determine the media pressure P_{Hp}_{_{—}}_{Calo} of the hydrogen H_{K} downstream from the condensation separator 14.

The control unit 9 uses the fixed predetermined values a, b, c, and d and the saturation vapor pressure P_{Hp}_{_{—}}_{Calo} to determine the required dew point value T_{TCalo} which corresponds to a nominal value of the measured temperature HT_Calo of the completely wetted hydrogen H_{vb}, using:

$$a * {T}_{TKalo} + b * {T}_{TKalo}^{2} + c * {T}_{TKalo}^{3} + d * {T}_{TKalo}^{4} = \frac{ln {p}_{SD \_ Kalo}}{ln 611} \\ \begin{matrix}a = 0.07257 \\ b = - 0.0002937 \\ c = 0.000000981 \\ d = - 1.901 * {10}^{- 9}\end{matrix} \qquad [ 8 ]$$

This determined dew point value T_{TCalo} is used as the nominal value for controlling the cooling circuit 12 via the control valve 13, in order to set the temperature H_{T}_{_{—}}_{Calo} of the completely wetted hydrogen H_{vb} on the output side of the reformat cooler 11 to the dew point value T_{TCalo}.

A separate device for wetting the fuel cell unit 1 of the anode 5 can advantageously be saved by using the control unit 9 to calculate the amount of water m_{w} required to wet the fuel cell unit 1, and with this amount of water m_{w} being set using the reformat cooler 11 and the downstream condensation separator 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SYMBOLS

1 Fuel cell unit
2 Supply container
3 Supply container
4 Ion exchange membrane
5 Anode
6 Cathode
7 Anode-side wetting device
8 Cathode-side wetting device
9 Control unit
10 Reformer
11 Reformat cooler
12 Cooling circuit
13 Control valve
14 Condensation separator
15 Pressure-maintenance valve
B Fuel
bH Wetted hydrogen
bL Wetted air
H Hydrogen
H₂O Water
H_{K} Hydrogen
H_{R} Hydrogen
HT_Calo Temperature
H_{vb} Completely wetted hydrogen
KT_{BE} Component-specific correction value
KT_{VT} Process correction value
KwT_Si Cooling water temperature
L Air
m_{L} Air mass flow
m_{R} Reformat mass flow
M_{R} Reformat molar mass
m_{w} Amount of water
M_{w} Water molar mass
m_{w1} Amount of water
m_{w2} Amount of water
P_{Hp}_{_{—}}_{Calo} Media pressure
P_{Hp-Si} Media pressure at the fuel cell inlet
Pₘ Media pressure
P_{SO} Vapor pressure in the saturation state
P_{SD}_{_{—}}_{Calo} Saturation vapor pressure
P_{SO}_{_{—}}_{Si} Vapor pressure in the saturation state
T_{H} Hydrogen temperature
T_{L} Air temperature
T_{ST} Dew point nominal value
T_{STcorr} Corrected dew point nominal value
T_{TCalo} Dew point value
U_{BE} Electrical voltage
V_{H} Hydrogen volume flow

1.-18. (canceled)

19. A method of operating a wetting device for wetting a fuel cell unit based on a predetermined dew point nominal value, as a function of an operating state of the fuel cell unit, said method comprising:
determining a corrected dew point nominal value using the predetermined dew point nominal value, a component-specific correction value and a process correction value; and
using the corrected dew point nominal value to set a required amount of water for optimum wetting of the fuel cell unit by said wetting device.

20. The method as claimed in claim 19, wherein the component-specific correction value is determined based on at least one of efficiency of the wetting device, a compression energy for vaporization of water, and a component temperature.

21. The method as claimed in claim 19, wherein the process correction value is determined from vaporization energy in the wetting device and a fuel temperature.

22. The method as claimed in claim 19, wherein a vapor pressure associated with the corrected dew point nominal value is determined in the saturation state for water.

23. The method as claimed in claim 22, wherein the amount of water necessary to wet the fuel cell unit is determined on the basis of vapor pressure in the saturation state for water and currently measured or calculated operating characteristic variables of the fuel cell unit.

24. The method as claimed in claim 23, wherein volume flow and pressure of a fuel, the mass flow of water and the mass flow of an oxidant are used as operating characteristic variables.

25. The method as claimed in claim 19, wherein the amount of water necessary for wetting is distributed via one of a wetting device and a plurality of wetting devices arranged in series or in parallel.

26. The method as claimed in claim 19, wherein the amount of water necessary for wetting the anode of a fuel cell unit with upstream fuel gas reformation is set on the basis of an adjustable reformation cooler and a temperature of the fuel downstream from a condensation separator which follows the reformat cooler.

27. The method as claimed in claim 26, wherein a completely wetted fuel is produced on an output side of the reformation cooler.

28. The method as claimed in claim 26, wherein the temperature of the fuel downstream from the condensation separator corresponds to a dew point temperature downstream from the condensation separator.

29. An apparatus for wetting a fuel cell unit based on a predetermined dew point nominal value, as a function of an operating state of the fuel cell unit, said apparatus comprising:
a wetting device; and
a control unit which uses the predetermined dew point nominal value, a component-specific correction value and a process correction value to determine a corrected dew point nominal value, and sets a required amount of water for optimum wetting of the fuel cell unit based on the corrected dew point nominal value.

30. The apparatus as claimed in claim 29, wherein the control unit determines the component-specific correction value based on at least one of efficiency of the wetting device, compression energy for vaporization of water and a component temperature.

31. The apparatus as claimed in claim 29, wherein the control unit determines the process correction value from the vaporization energy in the wetting device and the fuel temperature.

32. The apparatus as claimed in claim 29, wherein the control unit sets a saturation vapor pressure associated with the corrected dew point nominal value for water.

33. The apparatus as claimed in claim 32, wherein:
sensors detect operating characteristic variables of the fuel cell unit; and
the control unit uses calculated operating characteristic variables as well as the saturation vapor pressure for water to determine the required amount of water for wetting the fuel cell unit.

34. The apparatus as claimed in claim 29, wherein volume flow and pressure of a fuel, mass flow of water, and mass flow of an oxidant are used as operating characteristic variables.

35. The apparatus as claimed in claim 34, wherein at least one wetting device is provided to parallel distribute the required amount of water for wetting.

36. The apparatus as claimed in claim 35, wherein:
a plurality of wetting devices are provided; and
said wetting devices are arranged in a configuration that is at least one of series and parallel.

37. The apparatus as claimed in claim 29, wherein:
said fuel cell unit has a fuel gas reformation upstream of the anode;
the control unit uses an adjustable reformate cooler; and
temperature of the fuel downstream from a condensation separator which follows the reformate cooler is used to set the amount of water required for wetting at the anode.
